(19) United States
(12) Patent Application Publication
(10) Pub. No.: US 2023/0182723 A1
(43) Pub. Date: Jun. 15, 2023

(54) APPARATUS FOR CONTROLLING DRIVING OF VEHICLE AND METHOD THEREFORE

(71) Applicants: Hyundai Motor Company, Seoul (KR); Kia Corporation, Seoul (KR)

(72) Inventor: Jung Ho Lim, Seoul (KR)

(21) Appl. No.: 17/893,749

(22) Filed: Aug. 23, 2022

(30) Foreign Application Priority Data
Dec. 14, 2021 (KR) 10-2021-0178969

(51) Int. Cl. B60W 30/09; B60W 30/14; B60W 50/14; B60W 40/02; B60Q 1/20; B60Q 1/46; G06V 20/58; G06V 10/60; G06V 10/82

(52) U.S. Cl. CPC B60W 30/09; B60W 30/146; B60W 50/14; B60W 40/02; B60Q 1/20; B60Q 1/46; G06V 20/58; G06V 10/60; G06V 10/82; B60W 2050/143; B60W 2420/42; B60W 2554/80; B60W 2555/20; B60W 2555/60; B60Q 2300/312; B60Q 2300/45

(57) ABSTRACT

An apparatus for controlling driving of a vehicle and a method therefor are provided. The apparatus includes a learning device that classifies a fog situation into a plurality of levels based on deep learning and a controller that determines visible distances of a driver, which correspond to the plurality of levels, and controls driving of the vehicle based on a visible distance of the driver, which corresponds to a fog situation of a road where the vehicle is currently traveling

### CROSS-REFERENCE TO RELATED APPLICATION

This application is based on and claims under 35 U.S.C. § 119(a) the benefit of priority to Korean Patent Application No. 10-2021-0178969, filed in the Korean Intellectual Property Office on Dec. 14, 2021, the entire contents of which are incorporated herein by reference.

### TECHNICAL FIELD

Embodiments of the present disclosure relate to technologies of controlling driving of a vehicle with regard to a visible distance of a driver according to a fog situation of the road.

### BACKGROUND

In general, the artificial neural network (ANN) is one field of artificial intelligence, which is an algorithm allowing a machine to simulate and learn the human neural structure. Recently, the ANN has been applied to image recognition, speed recognition, natural language processing, and the like to show excellent effects. The ANN is composed of an input layer for receiving an input, a hidden layer for actually performing learning, and an output layer for returning the result of calculation. Having a plurality of hidden layers is referred to as a deep neural network (DNN). The DNN is a kind of ANN. The DNN may include a convolution neural network (CNN), a recurrent neural network (RNN), or the like depending on its structure, a problem to be solved, a purpose, and the like.

The ANN allows a computer to learn on its own based on data. When solving a certain problem using the ANN, what needs to be prepared is an appropriate ANN model and data to be analyzed. An ANN model for solving a problem is learned based on data. Prior to learning the model, there is a need for a work of dividing data into two types. In other words, data should be divided into a train dataset and a validation dataset. The train dataset is used to train the model, and the validation dataset is used to validate performance of the model.

There are several reasons for validating an ANN model. An ANN developer corrects a hyper parameter of the model based on the mode of validating the model to tune the model. Furthermore, the model is validated to select which model is suitable among several models. A description will be given in detail of the reason why model validation is necessary.

First, it is to predict accuracy. The purpose of the ANN is to achieve good performance on out-of-sample data which is not used for training Therefore, after creating the model, it is essential to verify how well the model will perform on out-of-sample data. However, because the model should not be validated using the train dataset, accuracy of the model should be measured using the validation dataset independent of the train dataset.

Secondly, the model is turned to enhance performance of the model. For example, overfitting may be prevented. The overfitting refers to when the model is overtrained on the train dataset. As an example, when training accuracy is high and when validation accuracy is low, the possibility of overfitting may be suspected. This may be identified in detail by means of a training loss and a validation loss. When the overfitting occurs, the overfitting should be prevented to enhance accuracy of validation. The overfitting may be prevented using a method such as regularization and dropout.

The model, the training process and the validation process of which are completed, may be applied to various systems to be used for various purposes.

An existing technology identifies a road state (e.g., a black ice, a pothole, a fog, or the like) from a road image using a machine learning model and controls driving of the vehicle based on the identified road state. When it is determined that the current driving environment is a fog situation without regard to a visible distance of a driver according to the fog situation, such an existing technology decreases driving satisfaction of the driver because of reducing a speed of the vehicle at all times.

Details described in the background art are written to increase the understanding of the background of the present disclosure, which may include details rather than an existing technology well known to those skilled in the art.

### SUMMARY

An embodiment of the present disclosure provides an apparatus for controlling driving of a vehicle to generate a classification model of classifying various fog situations into a plurality of levels based on deep learning, determine visible distances of a driver, which correspond to the plurality of levels, detect a visible distance of the driver, which corresponds to a fog situation of a road where the vehicle is currently traveling, and control driving of the vehicle based on the detected visible distance of the driver to improve driving stability of the vehicle without reducing driving satisfaction of the driver and a method therefor.

The purposes of the present disclosure are not limited to the aforementioned purposes, and any other purposes and advantages not mentioned herein will be clearly understood from the following description and may more clearly known by an exemplary embodiment of the present disclosure. Furthermore, it may be easily seen that purposes and advantages of the present disclosure may be implemented by means indicated in claims and a combination thereof.

According to an embodiment of the present disclosure, an apparatus for controlling driving of a vehicle may include a learning device that classifies a fog situation into a plurality of levels based on deep learning and a controller that determines visible distances of a driver, the visible distances corresponding to the plurality of levels, and controls driving of the vehicle based on a visible distance of the driver, the visible distance corresponding to a fog situation of a road where the vehicle is currently traveling.

In an exemplary embodiment of the present disclosure, the learning device may determine a level corresponding to a fog situation of a fog image based on a fog level and an illumination level of the fog image.

In an exemplary embodiment of the present disclosure, the apparatus may further include a storage that stores a table recording a visible distance of the driver, the visible distance corresponding to each level of the fog situation, each level being classified by the learning device. The controller may be configured to search the table for the visible distance of the driver, the visible distance corresponding to the fog situation of the road where the vehicle is currently traveling.

In an exemplary embodiment of the present disclosure, the learning device may perform convolution neural network (CNN)-based deep learning.

In an exemplary embodiment of the present disclosure, the controller may be configured to perform at least one of turning on fog lights and turning up volume of a guidance voice of a navigation module, when an obstacle is located within the visible distance of the driver.

In an exemplary embodiment of the present disclosure, the controller may be configured to control to maintain a lower speed between a speed limit of the road and a driving speed of the vehicle, when an obstacle is located out of the visible distance of the driver.

In an exemplary embodiment of the present disclosure, the controller may be configured to primarily decrease a speed of the vehicle to turn on/off hazard lights and may secondarily perform control of avoiding an obstacle, when the obstacle is located out of the visible distance of the driver.

In an exemplary embodiment of the present disclosure, the controller may be configured to maintain a lower speed between a speed limit of the road and a driving speed of the vehicle, when an obstacle is located out of the visible distance of the driver, may primarily decrease a speed of the vehicle to turn on/off hazard lights, and may secondarily perform control of avoiding the obstacle.

In an exemplary embodiment of the present disclosure, when an obstacle is located out of the visible distance of the driver, the controller is further configured to control an acceleration device to maintain a lower speed between a speed limit of the road and a driving speed of the vehicle, control a braking device to decrease a speed of the vehicle to control a warning device to turn on/off the hazard lights, and/or control a steering device to avoid the obstacle.

According to another embodiment of the present disclosure, a method for controlling driving of a vehicle may include classifying, by a learning device, a fog situation into a plurality of levels based on deep learning, determining, by a controller, visible distances of a driver, the visible distances corresponding to the plurality of levels, and controlling, by the controller, driving of the vehicle based on a visible distance of the driver, the visible distance corresponding to a fog situation of a road where the vehicle is currently traveling.

In an exemplary embodiment of the present disclosure, the classifying of the fog situation into the plurality of levels may include receiving a fog image and determining a level corresponding to a fog situation of the fog image based on a fog level and an illumination level of the fog image.

In an exemplary embodiment of the present disclosure, the method may further include storing, by a storage, a table recording a visible distance of the driver, the visible distance corresponding to each level of the fog situation.

In an exemplary embodiment of the present disclosure, the controlling of the driving of the vehicle may include searching the table for the visible distance of the driver, the visible distance corresponding to the fog situation of the road where the vehicle is currently traveling.

In an exemplary embodiment of the present disclosure, the classifying of the fog situation into the plurality of levels may include performing convolution neural network (CNN)-based deep learning.

In an exemplary embodiment of the present disclosure, the controlling of the driving of the vehicle may include performing at least one of turning on fog lights and turning up volume of a guidance voice of a navigation module, when an obstacle is located within the visible distance of the driver.

In an exemplary embodiment of the present disclosure, the controlling of the driving of the vehicle may include controlling to maintain a lower speed between a speed limit of the road and a driving speed of the vehicle, When an obstacle is located out of the visible distance of the driver.

In an exemplary embodiment of the present disclosure, the controlling of the driving of the vehicle may include primarily decreasing a speed of the vehicle to turn on/off hazard lights and secondarily performing control of avoiding an obstacle, when the obstacle is located out of the visible distance of the driver.

In an exemplary embodiment of the present disclosure, the controlling of the driving of the vehicle may include maintaining a lower speed between a speed limit of the road and a driving speed of the vehicle, when an obstacle is located out of the visible distance of the driver, primarily decreasing a speed of the vehicle to turn on/off hazard lights, and secondarily performing control of avoiding the obstacle. In an exemplary embodiment of the present disclosure, when an obstacle is located out of the visible distance of the driver, the controlling of the driving of the vehicle may include at least one of: controlling an acceleration device to maintain a lower speed between a speed limit of the road and a driving speed of the vehicle, controlling a braking device to decrease a speed of the vehicle to control a warning device to turn on/off the hazard lights, and controlling a steering device to avoid the obstacle.

As discussed, the method and system suitably include use of a controller or processer.

In another embodiment, vehicles are provided that comprise an apparatus as disclosed herein.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a vehicle system to which the present disclosure is applied;

FIG. 2 is a block diagram illustrating a configuration of an apparatus for controlling driving of a vehicle according to an exemplary embodiment of the present disclosure;

FIG. 3 is a drawing illustrating a process where a learning device provided in an apparatus for controlling driving of a vehicle performs learning based on a CNN according to an exemplary embodiment of the present disclosure;

FIG. 4 is a drawing illustrating fog images classified by a learning device provided in an apparatus for controlling driving of a vehicle according to an exemplary embodiment of the present disclosure;

FIG. 5 is a flowchart illustrating a method for controlling driving of a vehicle according to an exemplary embodiment of the present disclosure; and

FIG. 6 is a block diagram illustrating a computing system for executing a method for controlling driving of a vehicle according to an exemplary embodiment of the present disclosure.

### DETAILED DESCRIPTION

Hereinafter, some embodiments of the present disclosure will be described in detail with reference to the accompanying drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the corresponding components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” When used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Furthermore, unless otherwise defiled, all terms including technical and scientific terms used herein are to be interpreted as is customary in the art to which this disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

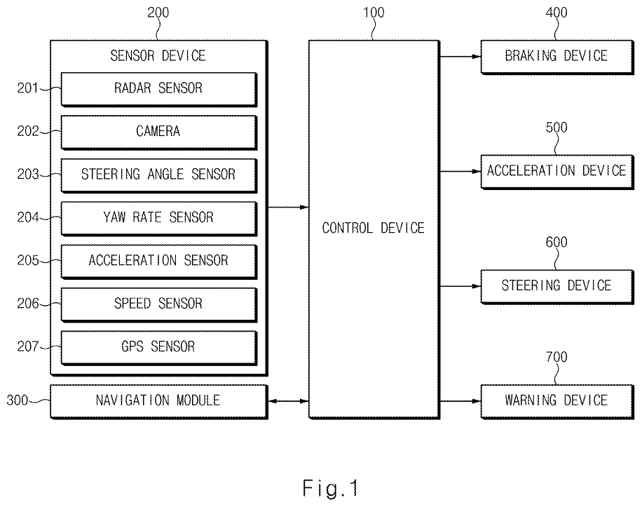

FIG. 1 is a block diagram illustrating a vehicle system to which the present disclosure is applied.

As shown in FIG. 1, the vehicle system to which the present disclosure is applied may include a control device 100, a sensor device 200, a navigation module 300, a braking device 400, an acceleration device 500, a steering device 600, and a warning device 700.

The sensor device 200 may be a group of sensors for detecting driving information of the vehicle, which may include a radar sensor 201, a camera 202, a steering angle sensor 203, a yaw rate sensor 204, an acceleration sensor 205, a speed sensor 206, and a global positioning system (GPS) sensor 207.

The radar sensor 201 may radiate a laser beam and may detect an obstacle located around the vehicle by means of the beam which is reflected from the obstacle to return, and may measure a time taken to be reflected from the obstacle to return to measure a distance from the obstacle.

The camera 202 may be implemented with a front view camera, a rear view camera, a first rear side view camera, and a second rear side view camera provided in a surround view monitoring (SVM) system to obtain an image around the vehicle. In this case, the front view camera may be mounted on a rear surface of a room mirror mounted in the vehicle to capture an image in front of the vehicle. The rear view camera may be mounted on the internal or external rear of the vehicle to capture an image behind the vehicle. The first rear side view camera may be mounted on a left side mirror position of the vehicle to capture a first rear side image of the vehicle. The second rear side view camera may be mounted on a right side mirror position of the vehicle to capture a second rear side image of the vehicle.

The camera 202 may be implemented as a multi function camera (MFC).

The steering angle sensor 203 may be installed in a steering column to detect a steering angle adjusted by a steering wheel.

The yaw rate sensor 204 may detect a yaw moment generated when the vehicle turns (e.g., when the vehicle turns in a left or right direction). Such a yaw rate sensor 204 may have a Celsium crystal element. As the vehicle moves and rotates, when the Celsium crystal element itself generates voltage while rotating, the yaw rate sensor 204 may measure a yaw rate of the vehicle based on the generated voltage.

The acceleration sensor 205 may be a module which measures acceleration of the vehicle, which may include a lateral acceleration sensor and a longitudinal acceleration sensor. In this case, when a movement direction of the vehicle is referred to as an X-axis and when the direction of a vertical axis (a Y-axis) of the movement direction is referred to as a lateral direction, the lateral acceleration sensor may measure a lateral acceleration. The lateral acceleration sensor may detect a lateral acceleration generated when the vehicle turns (e.g., when the user turns in a right direction). Furthermore, the longitudinal acceleration sensor may measure an acceleration of an X-axis direction which is the movement direction of the vehicle.

Such an acceleration sensor 205 may be an element which detects a change in speed per unit time, which may detect a dynamic force such as acceleration, vibration or impact and may measure acceleration using the principle of inertial force, electrostriction, or gyro.

The speed sensor 206 may be installed in each of a front wheel and a rear wheel of the vehicle to detect a vehicle speed of each wheel while driving.

The GPS sensor 207 may receive position information (e.g., GPS information) of the vehicle.

The navigation module 300 may receive pieces of position information from satellites by means of a plurality of GPSs to calculate a current position of the vehicle and may match and display the calculated position on a map. The navigation module 300 may receive a destination from a driver, may search for a route from the calculated current position to the destination depending on a predetermined route search algorithm, may match and display the found route on the map, and may guide the driver to the destination along the route.

The navigation module 300 may deliver map data to the control device 100 through a communication device or an AVN device. In this case, the map data may include road information, such as a position of the road, a length of the road, and a speed limit of the road, which is necessary for driving of the vehicle and route guidance. Furthermore, the road included in the map may be partitioned into a plurality of road sections on the basis of a distance or Whether it intersects another road. The map data may include a position of the line, information (e.g., an end point, a diverging, a merging point, or the like) of the line for each divided road section.

The braking device 400 may control brake hydraulic pressure supplied to a wheel cylinder depending on a braking signal output from the control device 100 to apply a braking force (or braking pressure) to a wheel of the vehicle.

The acceleration device 500 may control an engine torque depending to an engine control signal output from the control device 100 to control a driving force of the engine.

The steering device 600 may be an electric power steering (EPS) system, which may receive a target steering angle necessary for driving of the vehicle and may generate torque such that the wheel follows the target steering angle to be steered.

The warning device 700 may include a cluster, an audio video navigation (AVN) system, various lamp driving systems, a steering wheel vibration system, or the like and may provide the driver with visible, audible, and tactile warnings. Furthermore, the warning device 700 may warn persons (including another vehicle driver) around the vehicle using various lamps (e.g., fog lights and hazard lights) of the vehicle.

The control device 100 may be a processor which controls the overall operation of the vehicle, which may be a processor of an electronic device (e.g., an electronic control unit (ECU)) which controls the overall operation of a power system. The control device 100 may control operations (e.g., braking, acceleration, steering, warning, and the like) of various modules, devices, and the like embedded in the vehicle. The control device 100 may generate control signals for controlling various modules, devices, and the like embedded in the vehicle to control operations of respective components.

The control device 100 may use a controller area network (CAN) of the vehicle. The CAN may refer to a network system used for data transmission and control between ECUs of the vehicle. In detail, the CAN may transmit data through two-stranded data wiring which is twisted or shielded by a sheath. The CAN may operate according to a multi-master principle Where a plurality of ECUs perform a master function in a master/slave system. In addition, the control device 100 may communicate over a wired network, such as a local interconnect network (LIN) or a media oriented system transport (MOST) of the vehicle, or a wireless network, such as Bluetooth.

The control device 100 may include a memory for storing a program Which performs operations described above and below and various data associated with the program, a processor for executing the program stored in the memory, a hydraulic control unit (HCU), a micro controller unit (MCU), or the like. The control device 100 may be integrated into a system on chip (SOC) embedded in the vehicle and may operate by the processor. However, because only the one SOC embedded in the vehicle is not present and is able to be plural in number, the control device 100 is not limited to being integrated into only the one SOC.

The control device 100 may be implemented by means of at least one type of storage medium, such as a flash memory type memory, a hard disk type memory, a multimedia card micro type memory, a card type memory (e.g., a secure digital (SD) card or an extreme digital (XD) card), a random access memory (RAM), a static RAM (SRAM), a read-only memory (ROM), an electrically erasable programmable ROM (EEPROM), a programmable ROM (PROM), a magnetic memory, a magnetic disk, and an optical disk. However, the present disclosure is not limited thereto, which may be implemented in any another form known in the art.

The control device 100 may control driving of the vehicle based on the signal delivered from the sensor device 200 based on the map data delivered from the navigation module 300.

Particularly, the control device 100 may generate a classification model of classifying various fog situations into a plurality of levels based on deep learning, may determine visible distances of the driver, which correspond to the plurality of levels. may detect a visible distance of the driver, which corresponds to a fog situation of a road on which the vehicle is currently traveling, and may control driving of the vehicle based on the detected visible distance of the driver, thus improving driving stability of the vehicle without reducing driving satisfaction of the driver.

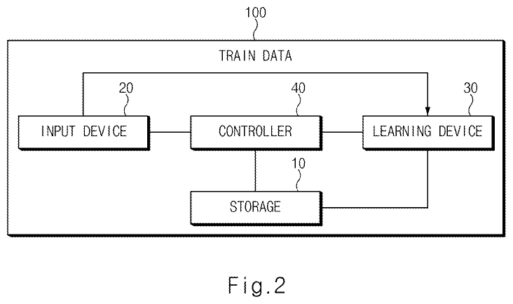

Hereinafter, a detailed configuration of the control device 100 will be described with reference to FIG. 2.

FIG. 2 is a block diagram illustrating a configuration of an apparatus for controlling driving of a vehicle according to an exemplary embodiment of the present disclosure.

As shown in FIG. 2, an apparatus 100 for controlling driving of a vehicle according to an exemplary embodiment of the present disclosure may include a storage 10, an input device 20, a learning device 30, and a controller 40. In this case, the respective components may be combined into one component and some components may be omitted, depending on a manner which executes the apparatus 100 for controlling the driving of the vehicle according to an exemplary embodiment of the present disclosure. Particularly, the learning device 30 may be one function block of the controller 40 to be implemented such that the controller 40 performs a function of the learning device 30.

Seeing the respective components, first of all, the storage 10 may store various logics, algorithms, and programs required in a process of generating a classification model of classifying various fog situations into a plurality of levels based on deep learning, determining visible distances of the driver, which correspond to the plurality of levels, detecting a visible distance of the driver, which corresponds to a fog situation of a road on which the vehicle is currently traveling, and controlling driving of the vehicle based on the detected visible distance of the driver.

The storage 10 may store a table in which the visible distances of the driver, which corresponding to the plurality of levels, are recorded. For example, the table is shown in Table 1 below.

TABLE 1

| Level of fog situation | Visible distance (m) of driver |
|---|---|
| S_L1_1 | A1 |
| S_L1_2 | A2 |
| S_L1_3 | A3 |
| S_L2_1 | B1 |
| S_L2_2 | B2 |
| S_L2_3 | B3 |
| S_L3_1 | C1 |
| S_L3_2 | C2 |
| S_L3_3 | C3 |
| . . . | . . . |

Table 1 above illustrates an example where the learning device 30 classifies fog situations of various fog images into 9 grades, but is not necessarily limited thereto. Herein, visible distance A1 is longest because level S_L1_1 is the lowest level, and visible distance C3 is shortest because level S_L3_3 is highest.

Such a storage 10 may include at least one type of storage medium, such as a flash memory type memory, a hard disk type memory, a micro type memory, a card type memory (e.g., a secure digital (SD) card or an extreme digital (XI)) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk

The input device 20 may input various types of fog images as train data to the learning device 30. Furthermore, the input device 20 may input a fog image captured by a camera 202 of FIG. 1, which is required in a process of identifying a fog situation of a road where the vehicle is traveling, to the controller 40.

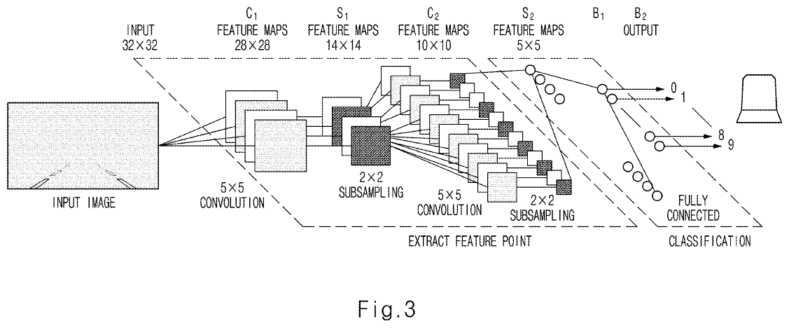

The learning device 30 may classify various types of fog images input from the input device 20 into a plurality of levels based on deep learning. In other words, the learning device 30 may extract a feature point from an input image (or a fog image) based on a convolution neural network (CNN) shown in FIG. 3 and may determine a level of the input image based on the extracted feature point. Such a learning device 30 may store a CNN, the learning of which is completed, as a classification model in the storage 10.

The controller 40 may perform the overall control such that respective components may normally perform their own functions. Such a controller 40 may be implemented in the form of hardware, may be implemented in the for in of software, or may be implemented in the form of a combination thereof. Preferably, the controller 40 may be implemented as, but not limited to, a microprocessor.

Particularly, the controller 40 may determine visible distances of the driver, which correspond to a plurality of levels from a classification model of classifying various fog situations into the plurality of levels, may detect a visible distance of the driver, which corresponds to a fog situation of a road where the vehicle is currently traveling, and may control driving of the vehicle based on the detected visible distance of the driver.

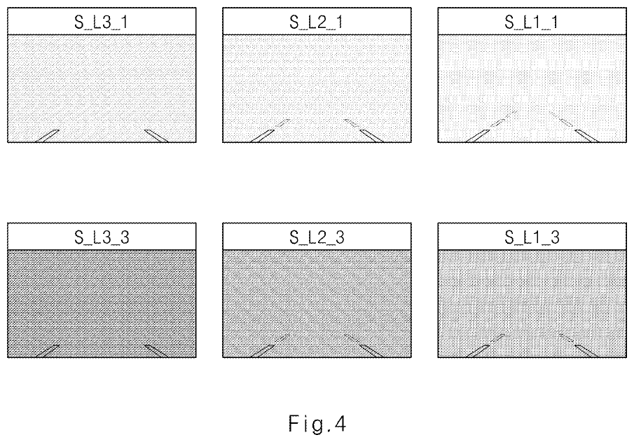

Furthermore, the controller 40 may generate a classification model of classifying various fog situations into a plurality of levels based on deep learning, may determine visible distances of the driver, Which correspond to the plurality of levels, may detect a visible distance of the driver, which corresponds to a fog situation of a road where the vehicle is currently traveling, and may control driving of the vehicle based on the detected visible distance of the driver. Hereinafter, the operation of the controller 40 will be described in detail with reference to FIG. 4.

FIG. 4 is a drawing illustrating fog images classified by a learning device provided in an apparatus for controlling driving of a vehicle according to an exemplary embodiment of the present disclosure.

First of all, a learning device 30 of FIG. 2 may divide a fog level in a fog image into three grades (i.e., grade 1, grade 2, and grade 3), may divide an illumination level in the fog image into three grades (i.e., grade 1, grade 2, and grade 3), and may divide a fog situation into ninth grades by means of a combination of the fog level and the illumination level, as classification parameters based on deep learning. Such divided ninth grades are shown in Table 2 below.

TABLE 2

| | Illumination | Illumination | Illumination |
|---|---|---|---|
| | level 1 | level 2 | level 3 |
| Fog level 1 | S_L1_1 | S_L1_2 | S_L1_3 |
| Fog level 2 | S_L2_1 | S_L2_2 | S_L2_3 |
| Fog level 3 | S_L3_1 | S_L3_2 | S_L3_3 |

In Table 2 above, the fog level is a grade where grade 3 is highest and indicates a state where fog is worst, and the illumination level is a grade where grade 3 is highest and indicates the darkest state. Herein, the fog level and the illumination level may be determined according to a brightness of a pixel.

Next, the learning device 30 may perform learning of classifying fog situations of various fog images into a plurality of levels based on a CNN. In this case, the learning device 30 may store a classification model, deep learning of which is completed, in a storage 10 of FIG. 2.

In FIG. 4, S_L1_1 is a grade indicating the lowest fog situation where the fog level is “1” and where the illumination level is “1”. It may be seen that the lines are relatively well visible in S_L1_1. S_L1_3 is a case where the fog level is “1”, but the illumination level is “3”. Visibility weakened by illumination is compensated to some extent by headlights. As compared with S_L1_1, it may be seen that a difference in fog situation is not large in S_L1_3. S_L3_3 is the most serious situation where the fog level is “3” and where the illumination level is “3”. It may be seen that the visible distance is shortest in S_L3_3.

A controller 40 of FIG. 2 may determine a visible distance of a driver, which corresponds to each level of the fog situation shown in Table 2 above. For example, the controller 40 may perform driving simulation for each level of the fog situation with respect to about 50 experimenters with corrected visual acuity of 1.0 and may determine a visible distance of the driver, which corresponds to each level of the fog situation based on the result of the driving simulation.

The controller 40 may determine a level according to a fog situation of a road where the vehicle is currently traveling, and may control driving of the vehicle based on a visible distance of the driver, which corresponds to the level.

For example, when an obstacle is located within the visible distance of the driver, the controller 40 may control a warning device 700 of FIG. 1 to turn on fog lights and may increase volume of a guidance voice of a navigation module 300 of FIG. 1. In other words, because it is able for the driver to identify an obstacle, the controller 40 does not need to unnecessarily lower a speed of the vehicle. As a result, driving satisfaction of the driver may be improved. In this case, although an obstacle is located within a visible distance of the driver, when a distance from the obstacle is within a reference distance, the controller 40 may primarily control a braking device 400 of FIG. 1 to decrease a speed of the vehicle to control the warning device 700 to turn on/off the hazard lights and may secondarily control a steering device 600 of FIG. 1 to avoid the obstacle.

For another example, when an obstacle is located out of a visible distance of the driver, the controller 40 may control an acceleration device 500 of FIG. 1 to maintain a lower speed between a speed limit of the road and a driving speed of the vehicle.

For another example, when an obstacle is located out of a visible distance of the driver, the controller 40 may control the acceleration device 500 to maintain a lower speed between a speed limit of the road and a driving speed of the vehicle, may primarily control the braking device 400 to decrease a speed of the vehicle to control the warning device 700 to turn on/off the hazard lights, and may secondarily control the steering device 600 to avoid the obstacle.

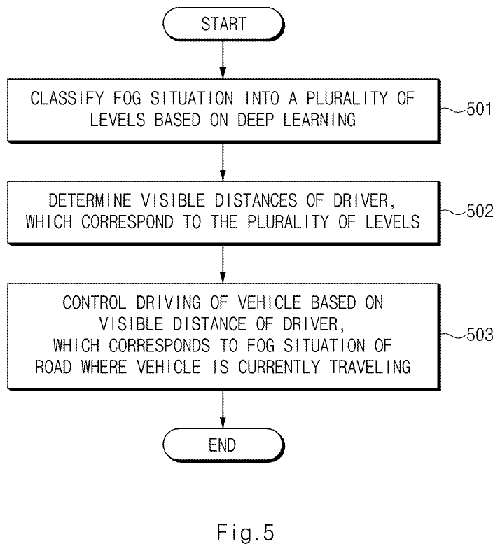

FIG. 5 is a flowchart illustrating a method for controlling driving of a vehicle according to an exemplary embodiment of the present disclosure.

First of all, in operation 501, a learning device 30 of FIG. 2 may classify a fog situation into a plurality of levels based on deep learning.

Thereafter, in operation 502, a controller 40 of FIG. 2 may determine visible distances of a driver, which correspond to the plurality of levels.

Thereafter, in operation 503, the controller 40 may control driving of the vehicle based on a visible distance of the driver, which corresponds to a fog situation of a road where the vehicle is currently traveling.

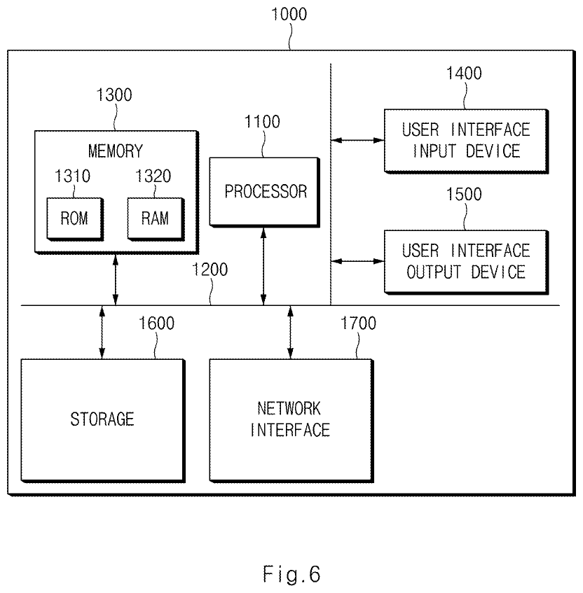

FIG. 6 is a block diagram illustrating a computing system for executing a method for controlling driving of a vehicle according to an exemplary embodiment of the present disclosure.

Referring to FIG. 6, the above-mentioned method for controlling the driving of the vehicle according to an exemplary embodiment of the present disclosure may be implemented by means of the computing system. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, an SSD (Solid State Drive), a removable disk, and a CD-ROM. The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The apparatus for controlling the driving of the vehicle and the method therefor according to an exemplary embodiment of the present disclosure may generate a classification model of classifying various fog situations into a plurality of levels based on deep learning, may determine visible distances of a driver, Which correspond to the plurality of levels, may detect a visible distance of the driver, which corresponds to a fog situation of a road where the vehicle is currently traveling, and may control driving of the vehicle based on the detected visible distance of the driver, thus improving driving stability of the vehicle without reducing driving satisfaction of the driver.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for controlling driving of a vehicle, the apparatus comprising:
a learning device configured to classify a fog situation into a plurality of levels based on deep learning; and.
a controller configured to determine visible distances of a driver, the visible distances corresponding to the plurality of levels, and control driving of the vehicle based on a visible distance of the driver, the visible distance corresponding to a fog situation of a road where the vehicle is currently traveling.

2. The apparatus of claim 1, wherein the learning device determines a level corresponding to a fog situation of a fog image based on a fog level and an illumination level of the fog image.

3. The apparatus of claim 1, further comprising:
a storage configured to store a table recording a visible distance of the driver, the visible distance corresponding to each level of the fog situation, each level being classified by the learning device.

4. The apparatus of claim 3, wherein the controller is further configured to search the table for the visible distance of the driver, the visible distance corresponding to the fog situation of the road where the vehicle is currently traveling.

5. The apparatus of claim 1, wherein the learning device performs convolution neural network (CNN)-based deep learning.

6. The apparatus of claim 1, wherein the controller is further configured to perform at least one of turning on fog lights and turning up volume of a guidance voice of a navigation module, when an obstacle is located within the visible distance of the driver.

7. The apparatus of claim 1, wherein the controller is further configured to control to maintain a lower speed between a speed limit of the road and a driving speed of the vehicle, when an obstacle is located out of the visible distance of the driver.

8. The apparatus of claim 1, wherein the controller is further configured to primarily decrease a speed of the vehicle to turn on/off hazard lights and secondarily performs control of avoiding an obstacle, when the obstacle is located out of the visible distance of the driver.

9. The apparatus of claim 1, wherein the controller is further configured to maintain a lower speed between a speed limit of the road and a driving speed of the vehicle, when an obstacle is located out of the visible distance of the driver, primarily decreases a speed of the vehicle to turn on/off hazard lights, and secondarily performs control of avoiding the obstacle.

10. The apparatus of claim 1, wherein when an obstacle is located out of the visible distance of the driver, the controller is further configured to control an acceleration device to maintain a lower speed between a speed limit of the road and a driving speed of the vehicle, control a braking device to decrease a speed of the vehicle to control a warning device to turn on/off the hazard lights, and/or control a steering device to avoid the obstacle.

11. A method for controlling driving of a vehicle, the method comprising:
classifying, by a learning device, a fog situation into a plurality of levels based on deep learning;
determining, by a controller, visible distances of a driver, the visible distances corresponding to the plurality of levels; and
controlling, by the controller, driving of the vehicle based on a visible distance of the driver, the visible distance corresponding to a fog situation of a road where the vehicle is currently traveling.

12. The method of claim 11, wherein the classifying of the fog situation into the plurality of levels comprises:
receiving a fog image; and
determining a level corresponding to a fog situation of the fog image based on a fog level and an illumination level of the fog image.

13. The method of claim 11, further comprising:
storing, by a storage, a table recording a visible distance of the driver, the visible distance corresponding to each level of the fog situation.

14. The method of claim 13, wherein the controlling of the driving of the vehicle comprises:
searching the table for the visible distance of the driver, the visible distance corresponding to the fog situation of the road where the vehicle is currently traveling.

15. The method of claim 11, wherein the classifying of the fog situation into the plurality of levels comprises:
performing convolution neural network (CNN)-based deep learning.

16. The method of claim 11, wherein the controlling of the driving of the vehicle comprises:
performing at least one of timing on fog lights and turning up volume of a guidance voice of a navigation module, when an obstacle is located within the visible distance of the driver.

17. The method of claim 11, wherein the controlling of the driving of the vehicle comprises:
controlling to maintain a lower speed between a speed limit of the road and a driving speed of the vehicle, When an obstacle is located out of the visible distance of the driver.

18. The method of claim 11, wherein the controlling of the driving of the vehicle comprises:
primarily decreasing a speed of the vehicle to turn on/off hazard lights and secondarily performing control of avoiding an obstacle, when the obstacle is located out of the visible distance of the driver.

19. The method of claim 11, wherein the controlling of the driving of the vehicle comprises:
maintaining a lower speed between a speed limit of the road and a driving speed of the vehicle, when an obstacle is located out of the visible distance of the driver, primarily decreasing a speed of the vehicle to turn on/off hazard lights, and secondarily performing control of avoiding the obstacle.

20. The method of claim 11, wherein when an obstacle is located out of the visible distance of the driver, the controlling of the vehicle comprises at least one of:
controlling an acceleration device to maintain a lower speed between a speed limit of the road and a driving speed of the vehicle,
controlling a braking device to decrease a speed of the vehicle to control a warning device to tum on/off the hazard lights, and
controlling a steering device to avoid the obstacle.
